(19) United States
(12) Patent Application Publication
(10) Pub. No.: US 2007/0134621 A1
(43) Pub. Date: Jun. 14, 2007

(54) Method and apparatus for cutting off dentine of a root canal

(76) Inventor: Yoshitsugu Terauchi, Yamato-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/290,435

(22) Filed: Dec. 1, 2005

(51) Int. Cl. A61C 5/02

(52) U.S. Cl. 433/102

(57) ABSTRACT

This invention provides a method for cutting off dentine of a root canal including the steps of, inserting a guide wire for guiding the cutting element into the root canal, and cutting off the dentine of the root canal with the cutting element.

### BACKGROUND OF THE INVENTION

1. Field of the Invention

The present invention relates to methods and apparatuses for dental instruments.

2. Description of the Related Art

The hard tissue of a tooth is corroded by lactic acid in which bacteria produce by digesting food remains in the oral cavity and results in dental caries. In the dental treatment, when a lesion involves a dental pulp, root canal therapy is performed to remove a content of the pulp. The root canal communicating with the pulp is enlarged as needed, and the operated tissues are sterilized, then the resulting cavity is filled with an inert material such as gattapercha.

It is easily anticipated that instruments which are used for enlargement of the root canal in root canal therapy such as files etc. will be contaminated with debris, bacteria, etc. in removing dentin, cement and pulp etc.

It is ideal, therefore, to use disposable instruments for every new patient to be treated. In practice, however, the dentist usually repeats washing and sterilizing non-disposable instruments every time after use, and keeps using them until they turn out to no longer endure further use functionally.

In the later phase of its life after the repeated use for a long time, it occurs not infrequently that a tip of the instrument is broken off during treatment. Once the resulting piece is left in the root canal of a treated tooth, it is difficult to deal with or remove the piece, and thus the piece is often left there.

### SUMMARY OF THE INVENTION

The present invention provides methods for cutting off dentine of a root canal of a tooth comprising steps of inserting a guide wire for guiding the cutting element into the root canal, the guide wire protruding from a distal end of the cutting element and guiding the cutting element by entering the root canal ahead of the cutting element; and cutting off the dentine of the root canal with the cutting element, the guide wire being retracted into the cutting element as the cutting element cuts off the dentine and goes further into the root canal.

The other aspects of the present invention will be apparent by the description of the present specification with reference to the attached figures.

### BRIEF DESCRIPTION OF THE DRAWINGS

FIG. 1A is an overview of a cutting device in an embodiment of this invention.

FIG. 1B shows the cross-sectional view of a cutting head.

FIG. 2 is an overview of the cutting device shown in FIG. 1A with adding a bellows portion at the proximal end of the cutting head.

FIG. 3 is an overview of a cutting device in another embodiment of this invention.

FIG. 4 is an overview of the cutting device of FIG. 1A attached to a head of a dental handpiece.

FIG. 5A is a sectional view of a root canal where the cutting device is penetrated deep into the root canal and about to cut off the dentine around a debris of the dental instrument.

FIG. 5B is a sectional view of the root canal after the cutting device cut off the dentine around a debris of the dental instrument.

FIG. 6A is a sectional view of a root canal where the cutting device is penetrated deep into the root canal and about to cut off the dentine around a debris of the dental instrument.

FIG. 6B is a sectional view of the root canal when the cutting device is cutting off the dentine around a debris of the dental instrument.

FIG. 6C is a sectional view of the root canal after the cutting device cut off the dentine around a debris of the dental instrument.

### DESCRIPTION OF THE PREFERRED EMBODIMENTS

The description of this specification with reference to the attached drawings will reveal at least the followings. However, the embodiments herein are not intended to limit in any way the scope of the invention, rather they are used as examples for the explanations and clarification of the invention and for enabling of people skilled in the art to utilize its teaching.

One embodiment of the present invention is directed to a method for cutting off dentine of a root canal. The method includes steps of inserting a guide wire for guiding the cutting element into the root canal, the guide wire protruding from a distal end of the cutting element and guiding the cutting element by entering the root canal ahead of the cutting element and cutting off the dentine of the root canal with the cutting element, the guide wire being retracted into the cutting element as the cutting element cuts off the dentine and goes further into the root canal.

In another embodiment of the present invention, the method further includes the step of inserting the cutting element for cutting off dentine of a root canal, the cutting element cutting off the dentine by following the guide wire which penetrates into the root canal until a tip of the guide wire reaches to an end surface in the root canal.

In yet another embodiment of the present invention, the method further includes the step of halting the cutting by the cutting element when the guide wire is completely retracted into a proximal end of the cutting element.

In yet another embodiment of the present invention, the method further includes the step of rotating the cutting element to cut off the dentine of the root canal.

Yet another embodiment of the present invention is directed to an apparatus for cutting off dentine of a root canal includes a handle to be held by an operator, a tube to be connected to a distal end of the handle, the tube being made from flexible material, a cutting element for cutting off dentine of a root canal, the cutting element being provided at a distal end of the tube and being able to be rotated, and a guide wire for guiding the cutting element, the guide wire passing through the cutting element and the tube, and being adapted to be retracted into the tube when the tip of the guide wire touches an end surface in the root canal and being pushed against the end surface.

In yet another embodiment of the present invention, the apparatus further includes an adjuster for adjusting the protruding length of the guide wire from the distal end of the cutting element, being provided on the handle and connected to the guide wire and being adapted to retract or project the guide wire.

In yet another embodiment of the present invention, the apparatus further includes a flexible portion provided at the tube, wherein the tube adapts its shape for a pathway of the root canal by flexing the flexible portion as the guide wire penetrates into a root canal.

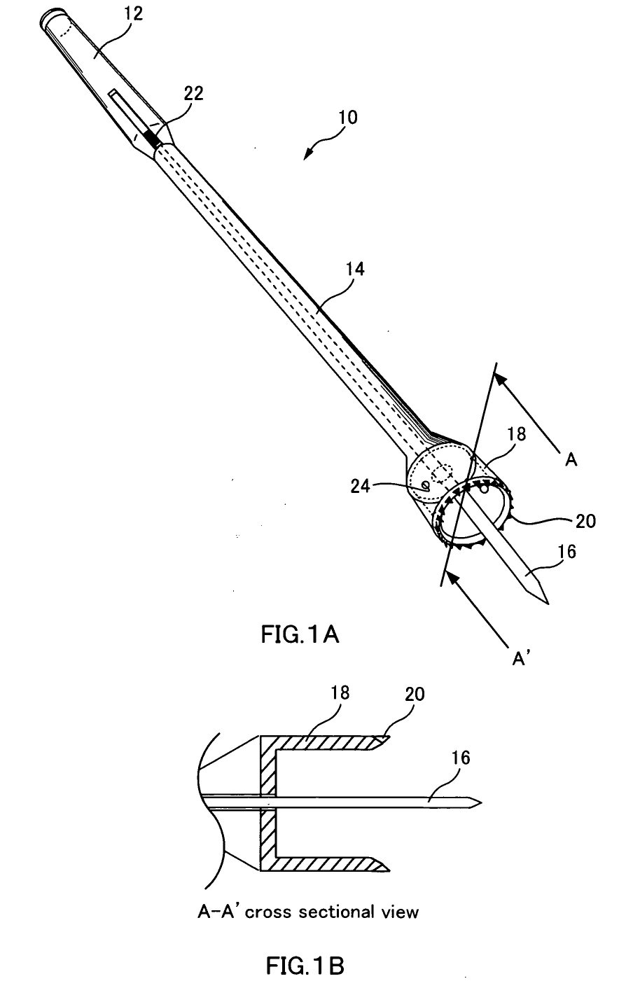

The cutting device 10 such as a cutting bur shown in FIG. 1A is provided with a handle 12 to be held by the operator.

The handle 12 is made from a material such as which ensures a size and a shape allowing easy hand gripping and handling, and permits easy sterilization, like common dental instruments. An adjuster 22 adjusts the length and tension of the guide wire 16 by sliding it back and forth along the handle 12.

A tube 14, protruding from the distal end of the handle 12, is hollow and is made from flexible material including metal such as nickel, titanium, stainless steel, cobalt, chromium, and alloys of their combinations (for example, nickel titanium alloy, cobalt chromium alloy) and carbon fiber with a diameter of about 0.5 mm and a length of about 28 mm to 30 mm.

The cutting head 18, which is provided at the distal end of the tube 14, is a hollow cylinder as shown in FIG. 1B with a diameter of about 0.8 mm and a cylindrical length of about 1.5 mm to 2.0 mm. This length has to be less than equal to 2.0 mm otherwise it would not be able to penetrate deep into the root canal to cut off dentine or would cut off a tooth itself. The proximal end of the cutting head 18 is cone-shaped hollow decreasing the size of the diameter so as to connect to the tube 14. The cutters 20 are provided at the edge of the cutting head 18 to cut off the dentine of root canal. When the cutting head 18 is rotated, the cutters 20 are also rotated to facilitate the cutting. A partition is provided at the proximal end of the cutting head 18 to prevent an inflow of the cutting debris into the tube 14.

The guide wire 16 is made of a single strong wire of stainless steel plated with nickel on its outer surface with a diameter between 0.04 mm to 0.12 mm. As shown in FIG. 1A, a proximal end of the guide wire 16 is connected to the inside of the handle 12 and passing through the inside of the tube 14 and the cutting head 18, and is protruding from the cutting head 18. The distal end, which is a tip, of the guide wire 16 is sharpened so that it would be able to easily sting an end surface. The end surface is basically a surface at an end of the pass way of the root canal, which may be a surface of dentine, debris of dental instruments such as file, Gates-Glidden drill, peeso reamer, Largo bur, or lentulo spiral, obturation material, posts, implants, or tools left in the root canal.

The function of the guide wire 16 is to lead a traveling direction of the cutting device 10 when it is penetrating deep into the root canal. In other words, the guide wire 16 assists the cutting device 10 to smoothly penetrate deep into the root canal without hurting and proceed the cutting process which is described hereafter.

Without the guide wire 16, the cutting device 10 cannot stabilize the traveling direction, and may require several trials to arrive at the target point in the end surface or may not be able to arrive there at all. During the several trials, the cutting device 10 may hurt the inside of the root canal with the cutters 20 or may suddenly go off the cutting track and cut off the unnecessary dentine in the root canal.

When the tip of the guide wire 16 arrives at the end surface, it attaches to the end surface. Since the cutting device 10 keeps on moving the traveling direction, a pressure applies to the tip of the guide wire 16. The guide wire 16 is adapted to be retracted into the tube 14, so the tip of the guide wire 16 is pushed back into the cutting head 18 as the cutting device proceeds.

As shown in FIG. 1A, an adjuster 22 is provided at the disto-lateral side of the handle 12. The adjuster 22 works as a slide switch that can control the protruding length of the guide wire 16, because it is in association with the guide wire 16. When the adjuster 22 is pulled backward, the protruding length is decreased because the guide wire 16 is retracted into the tube 14. The adjuster 22 is adapted to retract the guide wire 16 until the tip of the guide wire 16 is at the proximal end of the cutting head 18. When the adjuster 22 is pushed, the tip of the guide wire 16 is projected so that the protruding length is increased.

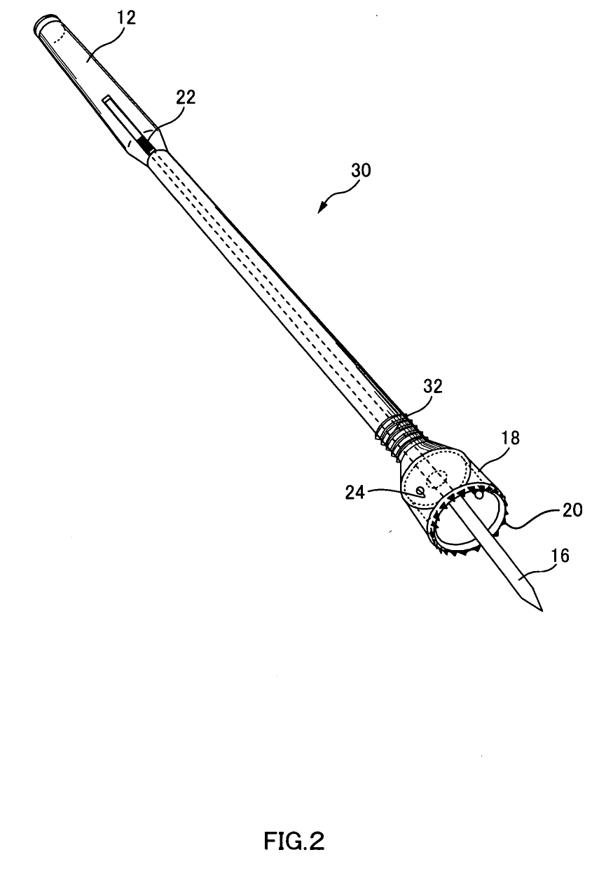

In another embodiment, the cutting device 30 is provided with a bellows portion 32 as shown in FIG. 2. The bellows portion 32 is provided at the distal end of the tube 14 to assist bending of the tube 14 by flexing itself. The bellows portion 32 is configured to be flexible so that the cutting head 18 is able to change the traveling direction easily.

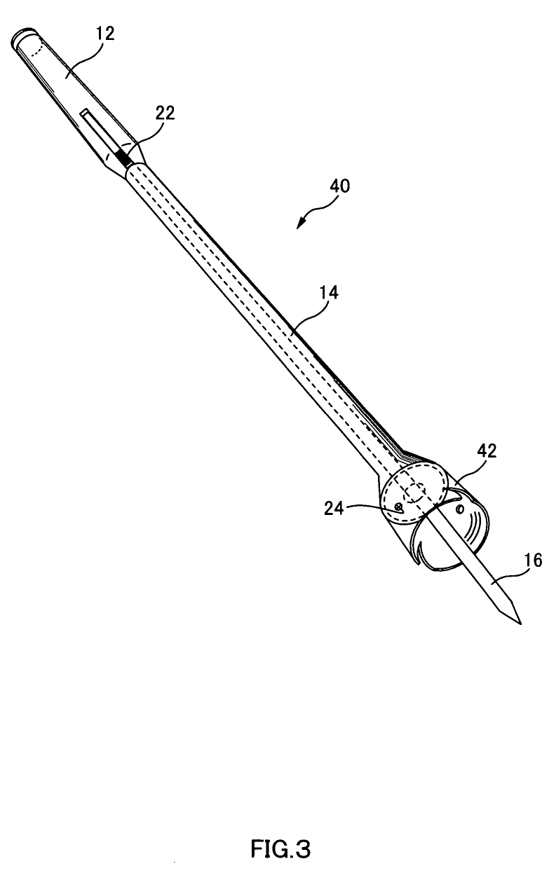

In still another embodiment, the cutting device 40 may have the cutting head 42 as shown in FIG. 3. Instead of cutters 20, notches are provided at the edge of the cutting head 42 that can cut off the dentine of the root canal using the notches. To assist bending of the tube 14, the bellows portion 32 may be provided at the distal end of the tube 14 (not shown).

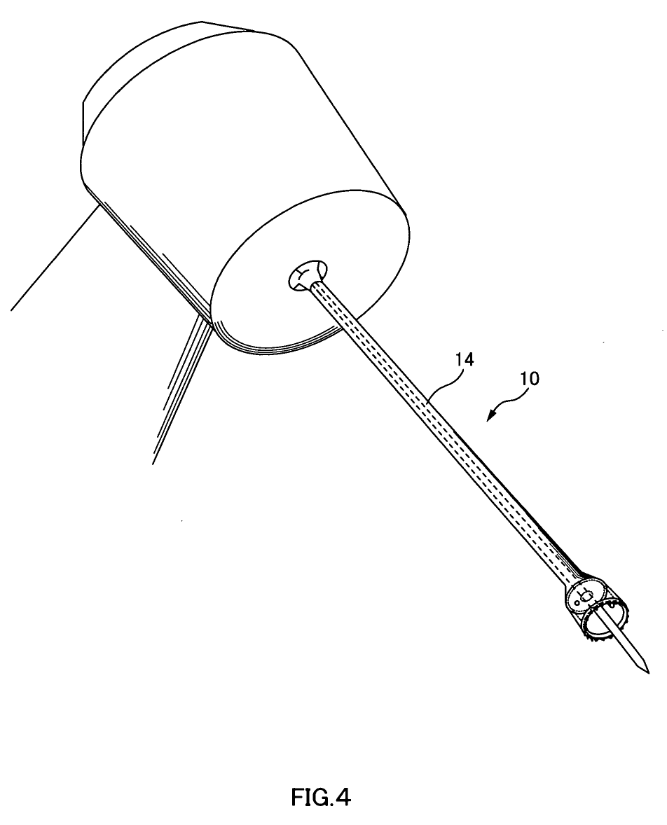

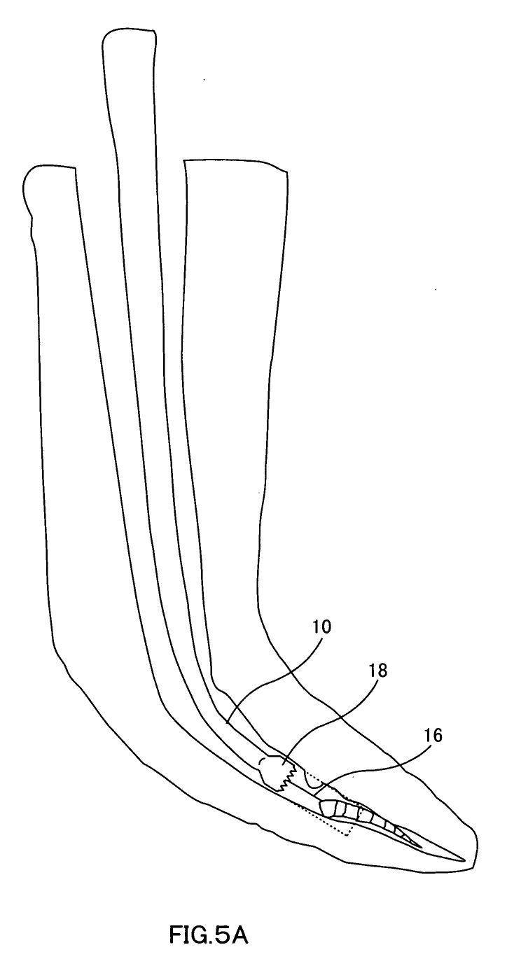

As shown in FIG. 4, the tube 14 of the cutting device 10 is connected to a dental device called a dental handpiece, which is air-driven or electric motor driven, including, but not limited to, a low-speed handpiece or a contra-angle handpiece. In this case, the handle 12 is replaced with the handle of the dental handpiece and the adjuster 22 can be provided at the dental handpiece (not shown). The cutting devices 30 and 40 can be also connected to the dental handpiece in the same manner.

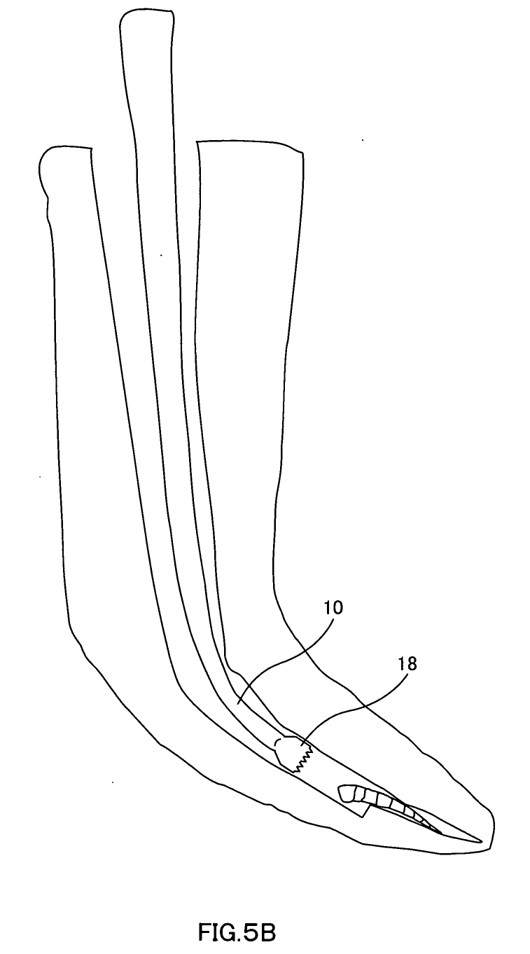

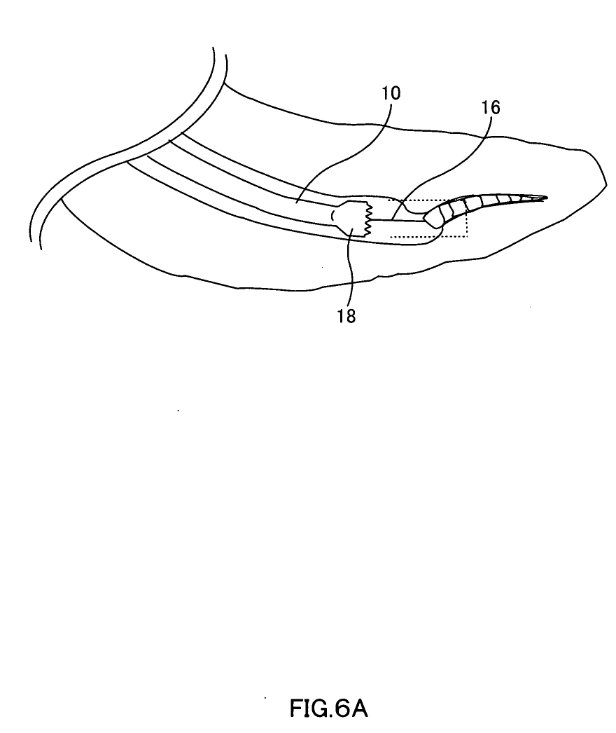

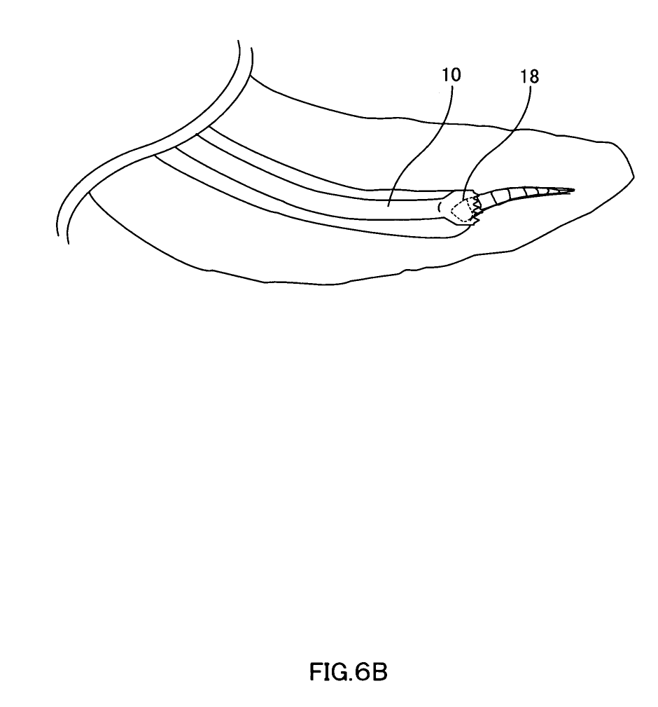

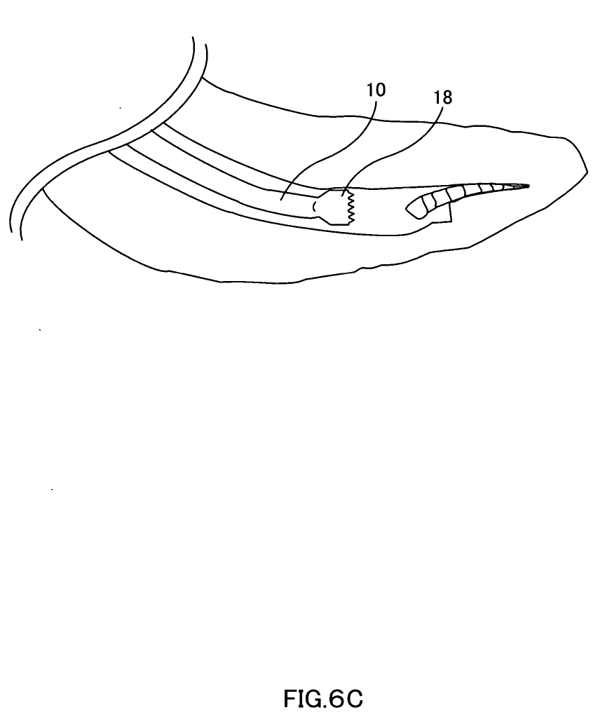

A method for cutting off dentine of a root canal is explained hereafter using the cutting device 10 and FIGS. 5A to 6C. It should be noted that the method can be accomplished by the cutting devices 10, 30, 40, and any other modified cutting devices based upon three cutting devices 10, 30, and 40.

As shown in FIGS. 5A and 6A, when the cutting head 18 of the cutting device 10 is inserted into a root canal, it penetrates along the pass way of the root canal. The guide wire 16 leads the traveling direction of the cutting head 18 to penetrate further into the root canal. When the cutting head 18 approaches to an end surface, which is a dental instrument debris in this case, in the root canal, the tip of the guide wire 16 attaches the debris so that the traveling direction is fixed. As the cutting head 18 further penetrates, it retracts the guide wire 16 and cuts off the dentine in the way. Rotating the cutting head 18 facilitates this cutting process. The dotted lines in FIGS. 5A and 6A indicate a section where the cutting head 18 cuts off. The cutting process halts when the guide wire 16 is completely retracted into the proximal end of the cutting head 18 as shown in FIG. 6B.

Further, the cutting device 10 may include an apparatus that halts the cutting process by halting the rotation of the cutting head 18 when the protruding length of the guide wire 16 from the proximal end of the cutting head 18 reaches to a certain length. This length can be predetermined by an operator as the best suited length of the practical use. For example, the cutting process may be halted when the guide wire 16 is retracted to the proximal end, 0.1 mm from the proximal end, the distal end of the cutting head 18.

The hollow portion of cutting head 18 can contain the debris and the dentine cut by the cutting head 18, and the dentine can be discharged from the small holes 24. While the traveling direction is fixed, the cutting head 18 cuts off the dentine to expose a coronal portion of the debris. Usually the diameter of the debris is smaller than that of the cutting head 18, but when the diameter of the debris is bigger, the cutting head 18 cuts off the dentine around the debris numerous times or is replaced with the bigger diameter of the cutting head 18 so that the cutting head 18 can contain the debris and cuts off the dentine to create some space around the debris.

After finishing the cutting process, the cutting device 10 is pulled out of the root canal and leaves the space around the debris as shown in FIGS. 5B and 6C.

### REFERENCE NUMERALS IN THE FIGURES

10, 30, 40: Cutting device; 12: Handle; 14: Tube; 16: Guide wire; 18, 42: Cutting head; 20: Cutter; 22: Adjuster; 24: Small hole; 32: Bellows portion;

What is claimed is:

1. A method for cutting off dentine of a root canal comprising:
inserting a guide wire for guiding the cutting element into the root canal, the guide wire protruding from a distal end of the cutting element and guiding the cutting element by entering the root canal ahead of the cutting element; and
cutting off the dentine of the root canal with the cutting element, the guide wire being retracted into the cutting element as the cutting element cuts off the dentine and goes further into the root canal.

2. A method for cutting off dentine of a root canal as set forth in claim 1 further comprising:
inserting the cutting element for cutting off dentine of a root canal, the cutting element cutting off the dentine by following the guide wire which penetrates into the root canal until a tip of the guide wire reaches to an end surface in the root canal.

3. A method for cutting off dentine of a root canal as set forth in claim 1 further comprising:
inserting the cutting element for cutting off dentine of a root canal, the cutting element cutting off the dentine by following the guide wire after a tip of the guide wire reaches to an end surface in the root canal.

4. A method for cutting off dentine of a root canal as set forth in claim 3 further comprising:
halting the cutting by the cutting element when the guide wire is completely retracted into a proximal end of the cutting element.

5. A method for cutting off dentine of a root canal as set forth in claim 3 further comprising:
rotating the cutting element to cut off the dentine of the root canal.

6. An apparatus for cutting off dentine of a root canal comprising:
a handle to be held by an operator;
a tube to be connected to a distal end of the handle, the tube being made from flexible material;
a cutting element for cutting off dentine of a root canal, the cutting element being provided at a distal end of the tube and being able to be rotated; and
a guide wire for guiding the cutting element, the guide wire passing through the cutting element and the tube, and being adapted to be retracted into the tube when the tip of the guide wire touches an end surface in the root canal and being pushed against the end surface.

7. An apparatus for cutting off dentine of a root canal as set forth in claim 6 further comprising:
an adjuster for adjusting the protruding length of the guide wire from the distal end of the cutting element, being provided on the handle and connected to the guide wire and being adapted to retract or project the guide wire.

8. An apparatus for cutting off dentine of a root canal as set forth in claim 6 further comprising
a flexible portion provided at the tube;
wherein the tube adapts its shape for a pathway of the root canal by flexing the flexible portion as the guide wire penetrates into the root canal.
